(19) United States
(12) Patent Application Publication
(10) Pub. No.: US 2005/0023834 A1
(43) Pub. Date: Feb. 3, 2005

(54) Starter

(75) Inventor: Paul David Coates, Darlington (GB)

Correspondence Address: PEARNE & GORDON LLP, 1801 EAST 9TH STREET, SUITE 1200, CLEVELAND, OH, 44114-3108, US

(73) Assignee: Electrolux Outdoor Products Limited, Newton Aycliffe (GB)

(21) Appl. No.: 10/885,945

(22) Filed: Jul. 7, 2004

(30) Foreign Application Priority Data
Jul. 7, 2003 (GB) 0315855.7

(51) Int. Cl. H02P 9/04; F02N 11/00

(52) U.S. Cl. 290/38 R

(57) ABSTRACT

An electric starter for an internal combustion engine comprises a switch (1) connectable to the starter motor of the engine, an actuator (3) for actuating the switch, and a removable operating element (4) for operating the actuator. The actuator (4) is a push-button actuator.

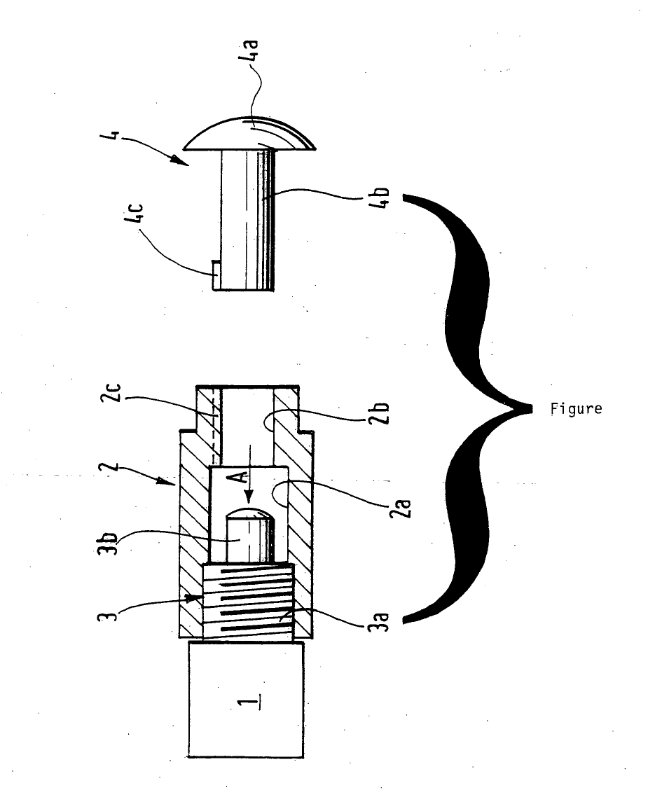

This invention relates to an electric starter for a petrol powered lawnmower.

A conventional petrol lawnmower is provided with a pull cord for starting the internal combustion engine of the lawnmower. This pull cord starter arrangement can be supplemented by the provision of an electric starter switch, the switch being operated by means of a key turning in a key slot provided in the switch housing. Such a switch is connected at one end of a wiring harness, with the engine starter motor and battery at the opposite end of the harness.

One disadvantage of this known electric starter switch is that it is a relatively complicated and expensive construction. Moreover, there is a danger of the key being hit in use, which could lead to the key being broken within the key slot, in which case, a relatively costly repair would be necessary.

The present invention provides an electric starter for an internal combustion engine, the starter comprising a switch connectable to the starter motor of the engine, an actuator for actuating the switch, and a removable operating element for operating the actuator, wherein the actuator is a push-button actuator.

Preferably, the actuator is mounted within a hollow housing associated with the switch, and the operating element is reciprocally mounted within the housing. Conveniently, the operating element has a shaft, and one end of the housing is provided with an aperture leading to its hollow interior, the aperture complementing the cross-section of the shaft, the shaft and the aperture being formed with complementary, interengageable projection/ recessed portions.

Advantageously, the operating element is provided with a manually-engageable head portion at that end of the shaft remote from the key projection.

Advantageously, the body portion of the actuator is fixed within the housing by means of a screw-threaded connection. Alternatively, the body portion of the actuator is fixed within the housing by snap-fitting.

Preferably, the actuator has a body portion fixed to the switch, and an actuator portion reciprocally mounted within the body portion for movement towards, and away from, the switch. Preferably, the housing is fixed to the body portion of the actuator with the actuator portion positioned within its hollow interior and in alignment with the aperture in said one end of the housing.

The invention will now be described in greater detail, by way of example, with reference to the drawing, the single figure of which is a schematic representation of a petrol lawnmower electric starter switch arrangement.

Referring to the drawing, an electric switch 1 for starting the internal combustion engine of a petrol powered lawnmower (not shown) is mounted within a housing 2. The switch 1 is provided with a push button actuator 3 having a body 3a and a push button 3b mounted for reciprocal movement within the body. A spring (not shown) is provided within the switch 1 to bias the push button 3b towards the position shown in the drawing. In order to actuate the switch 1, it is necessary to push the button 3b in the direction of the arrow A. The body 3a of the push button 3 is fixed within a bore 2a of the housing 2 by means of a screw-threaded connection. Alternatively, the body 3a of the push button actuator 3 is a snap fit within the housing 2.

A removable button key 4 is provided for engagement with the actuator 3 to actuate the switch 1. The key 4 has a head 4a, generally cylindrical shaft 4b, and a key projection 4c. The bore 2a of the housing 2 has a stepped-in portion 2b at its free end, the diameter of this stepped-in portion being slightly greater than that of the shaft 4b of the key 4. A slot 2c, which complements the key projection 4c, is provided in the stepped-in portion 2b.

In use, the key projection 4c of the key 4 is aligned with the slot 2c, and the key is pushed into the housing 2. Once the key projection 4c enters the bore 2a of the housing 2, the key 4 can be rotated to hold the key with in the housing, thereby preventing the key becoming accidentally loose in use. To start the lawnmower, the key 4 is then pressed into the housing 2 as far as possible, thereby pushing the button 3b in the direction of the arrow A against the force of the spring, and actuating the switch 1 to fire the engine starter motor.

Once the lawnmower engine has started, pressure on the key 4 is relaxed, the button 3b returns to the position shown in the drawing under the action of the spring, and the key is held as a loose fit within the housing 2. A separate switch (not shown) known as an operator presence control or dead man's handle is provided for turning off the engine of the lawnmower.

The main benefits of the electric starter switch arrangement described above are that it is cheaper to manufacture, and much simpler to operate than the known ignition key system, whilst maintaining the same safety advantages. Thus, the housing 2 and the key 4 can be manufactured very simply and cheaply by moulding processes using a plastics material such as glass-filled nylon or ABS, and the push button actuator 3 is a cheap and simple part to manufacture.

1. An electric starter for an internal combustion engine, the starter comprising a switch connectable to the starter motor of the engine, a push-button actuator for actuating the switch, and a removable operating element for operating the actuator, the actuator being mounted within a housing associated with the switch, and the operating element being reciprocally mounted within the housing, wherein the operating element has a shaft and one end of the housing is provided with an aperture leading to its hollow interior, the aperture complementing the cross-section of the shaft, the shaft and the aperture being formed with complementary, interchangeable projection/recessed portions.

2-3. (cancelled)

4. A starter as claimed in claim 1, wherein the shaft is formed with an outwardly-extending key projection at one end thereof, and the aperture is formed with an outwardly-recessed portion whose shape complements that of the key projection.

5. A starter as claimed in claim 1, wherein the operating element is provided with a manually-engageable head portion at that end of the shaft remote from the key projection.

6. A starter as claimed in claim 1, wherein the actuator has a body portion fixed to the switch, and an actuator portion (push button) reciprocally mounted within the body portion for movement towards, and away from, the switch.

7. A starter as claimed in claim 4, wherein the body portion of the actuator is fixed within the housing by means of a screw-threaded connection.

8. A starter as claimed in claim 4, wherein the body portion of the actuator is fixed within the housing by snap-fitting.

9. A switch as claimed in claim 4, wherein the housing is fixed to the body portion of the actuator with the actuator portion positioned within its hollow interior and in alignment with the aperture in said one end of the housing.
